(19) United States
(12) Patent Application Publication
(10) Pub. No.: US 2019/0272093 A1
(43) Pub. Date: Sep. 5, 2019

(54) CHARACTER INPUT DEVICE, CHARACTER INPUT METHOD, AND CHARACTER INPUT PROGRAM

(71) Applicant: OMRON Corporation, Kyoto-shi (JP)

(72) Inventor: Yui NONOMURA, Kyoto-shi (JP)

(73) Assignee: OMRON Corporation, Kyoto-shi (JP)

(21) Appl. No.: 16/278,756

(22) Filed: Feb. 19, 2019

(30) Foreign Application Priority Data
Mar. 5, 2018 (JP) 2018-038659

(51) Int. Cl. G06F 3/0488; G06F 3/01; G06F 3/0489

(52) U.S. Cl. CPC G06F 3/04886; G06F 3/04897; G06F 3/017

(57) ABSTRACT

A character input device for inputting a character repositions a software keyboard in accordance with a hand gripping a mobile terminal without an external attachment. A character input device includes an operation unit included in a body of the character input device and including a software keyboard to receive a character input performed with the software keyboard, an attitude detector that detects an attitude change of the body, and a controller that repositions the software keyboard in accordance with the attitude change.

### CROSS-REFERENCE TO RELATED APPLICATION

This application claims priority to Japanese Patent Application No. 2018-038659 filed on Mar. 5, 2018, the contents of which are incorporated herein by reference.

### FIELD

The disclosure relates to a technique for inputting characters on a touchscreen input device.

### BACKGROUND

Patent Literature 1 describes a mobile terminal that detects a hand gripping the terminal and displays a software keyboard at a position appropriate for the gripping hand.

### CITATION LIST

### Patent Literature

Patent Literature 1: Japanese Unexamined Patent Application Publication No. 2015-162018

### SUMMARY

### Technical Problem

However, the mobile terminal in Patent Literature 1 uses an antenna attachment to position the software keyboard in accordance with the gripping hand, and is inconvenient.

One or more aspects are directed to a technique for repositioning a software keyboard in accordance with a hand gripping a mobile terminal without an external attachment.

### Solution to Problem

The character input device according to one or more aspects is used for inputting a character. The character input device includes an operation unit included in a body of the character input device and including a software keyboard to receive a character input performed with the software keyboard, an attitude detector that detects an attitude change of the body, and a controller that repositions the software keyboard in accordance with the attitude change.

This structure detects the attitude of the character input device body and repositions the software keyboard in accordance with the detected attitude, and thus improves usability.

The attitude detector included in the character input device may detect the attitude change by detecting a rightward tilt or a leftward tilt from a first attitude of the body.

This structure repositions the software keyboard in accordance with a rightward or leftward tilt that depends on the gripping hand of the user.

When the attitude detector detects the body oriented in a second attitude relative to the first attitude, the controller included in the character input device may reposition the software keyboard in accordance with the second attitude.

This structure repositions the software keyboard in accordance with the body attitude, and further improves usability.

The controller included in the character input device may return the position of the software keyboard to a default when the character input ends.

This structure eliminates manual resetting of the software keyboard, and thus improves usability.

### Advantageous Effects

The structure according to one or more aspects repositions the software keyboard in accordance with the gripping hand without an external attachment.

### BRIEF DESCRIPTION OF THE DRAWINGS

FIG. 1 is a block diagram illustrating a character input device according to a first embodiment.

FIGS. 2A, 2B, and 2C are schematic diagrams illustrating a character input device according to a first embodiment.

FIGS. 3A, 3B, and 3C are schematic diagrams illustrating an operation unit included in a character input device according to a first embodiment.

FIG. 4 is a flowchart illustrating an operation of a character input device according to a first embodiment.

FIG. 5 is a schematic diagram illustrating a character input device according to a first embodiment.

FIG. 6 is a flow diagram illustrating an operation of a character input device according to a first embodiment.

FIGS. 7A and 7B are schematic diagrams illustrating a character input device according to a second embodiment.

### DETAILED DESCRIPTION

Embodiments will now be described with reference to the drawings.

### Example Use

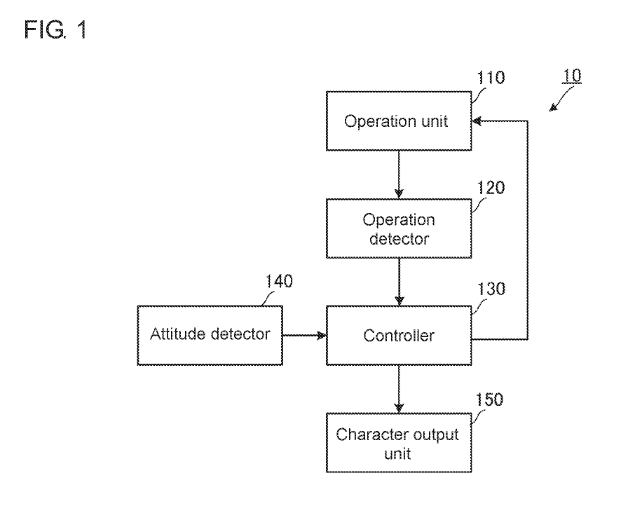

An embodiment will be described first with reference to FIG. 1. FIG. 1 is a block diagram of a character input device according to a first embodiment. A character input device 10 is installed in, for example, a mobile communication terminal such as a smartphone, and allows a user to input characters by performing an operation on a touchscreen display.

The character input device 10 includes an operation unit 110, an operation detector 120, a controller 130, an attitude detector 140, and a character output unit 150. The operation unit 110 is a software keyboard. A character input operation described below is an operation performed with one hand.

The attitude detector 140 is, for example, a gyro sensor. Mobile terminals including various smartphones or tablets typically use gyro sensors.

In the example described below, the user grips the character input device 10 in the left hand and activates the character input function for a key entry operation. The user tilts the character input device 10 to the left with the left hand. The tilt to the left refers to a horizontally leftward tilt as viewed from the front of the operation unit 110 and the character output unit 150 in the character input device 10.

The attitude detector 140 detects a leftward tilt of the character input device 10, and outputs the leftward tilt information to the controller 130.

The controller 130 displays the operation unit 110 to the left. More specifically, the controller 130 displays the operation unit 110 shifted in the direction in which the left hand of the user tilts.

The user inputs a character with the operation unit 110 displayed to the left. The operation detector 120 detects the character input and outputs the input to the controller 130.

The controller 130 outputs the character input to the character output unit 150.

In the example described below, the user grips the character input device 10 in the right hand and activates the character input function for a key entry operation. The user tilts the character input device 10 to the right with the right hand. The tilt to the right refers to a horizontally rightward tilt as viewed from the front of the operation unit 110 and the character output unit 150 in the character input device 10.

The attitude detector 140 detects a rightward tilt of the character input device 10, and outputs the rightward tilt information to the controller 130.

The controller 130 displays the operation unit 110 to the right. More specifically, the controller 130 displays the operation unit 110 shifted in the direction in which the right hand of the user tilts.

The user inputs a character with the operation unit 110 displayed to the right. The operation detector 120 detects the character input and outputs the input to the controller 130.

The controller 130 outputs the character input to the character output unit 150.

In this manner, the operation unit 110 can be repositioned in accordance with a tilt and the corresponding attitude change of the character input device 10. More specifically, the operation unit 110 is shifted to within the reach of the user's thumb during a one-hand operation with the right or left hand to enable the user to easily input a character. The user can thus input a character with improved usability.

### Example Structure 1

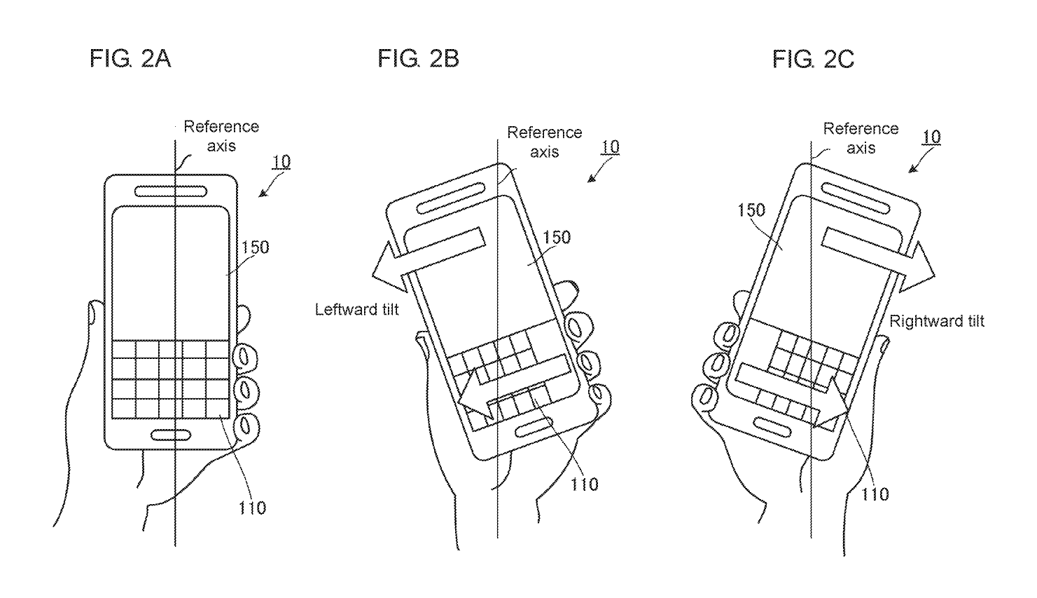

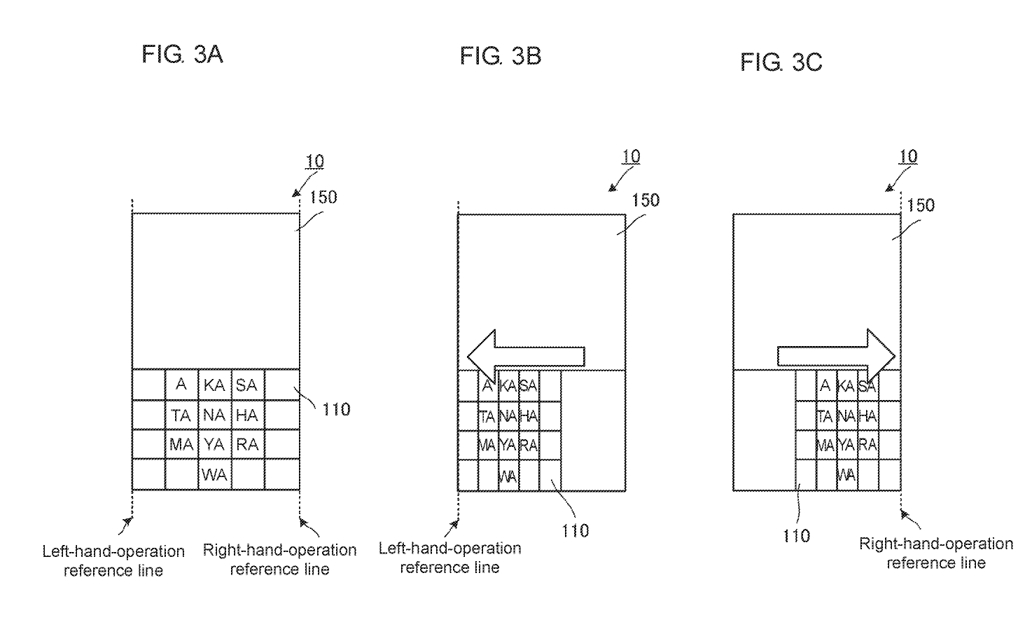

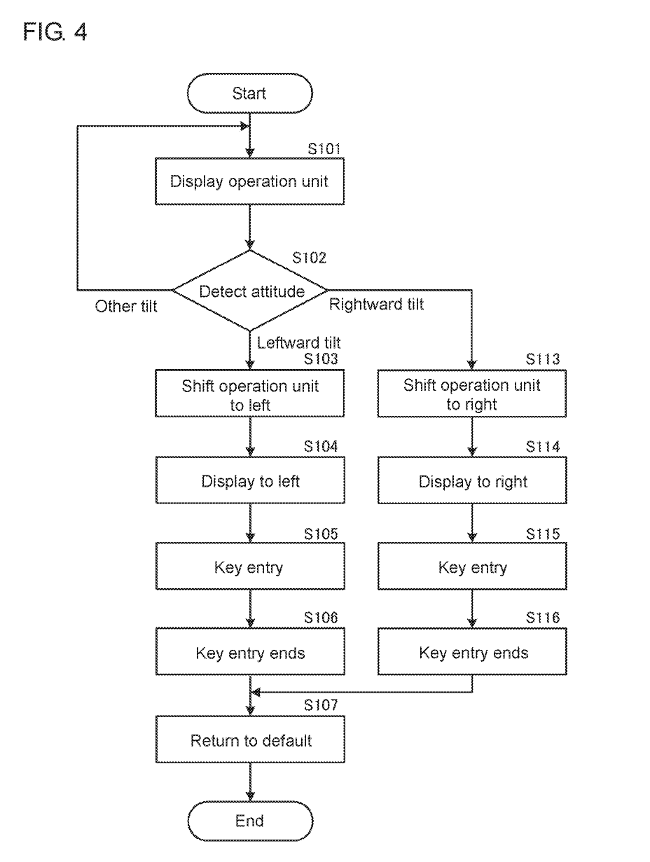

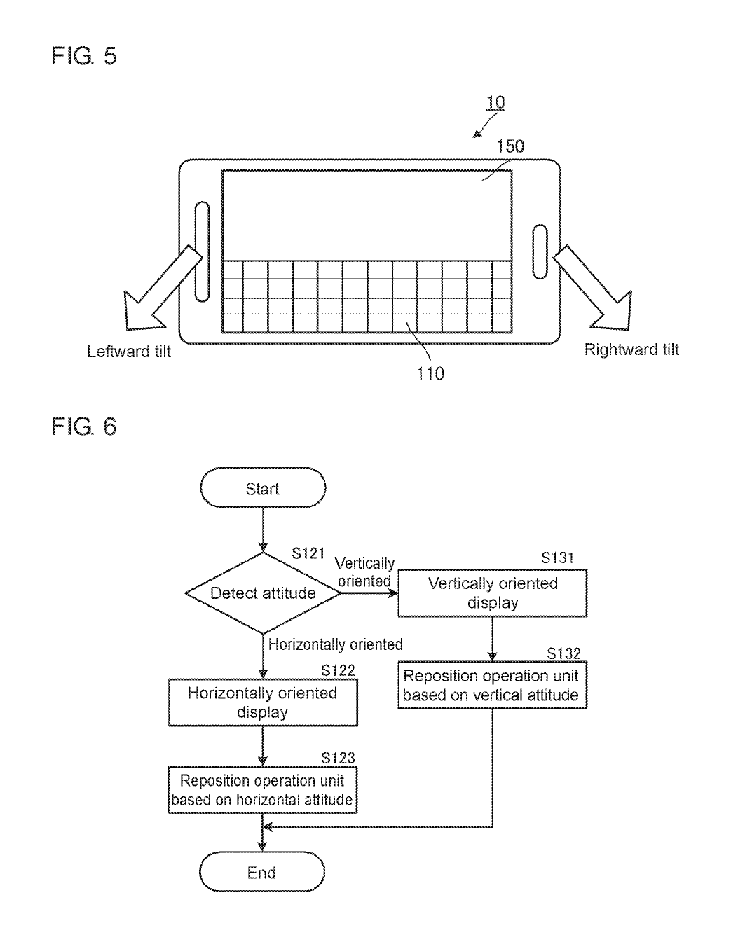

FIG. 1 is a block diagram of the character input device according to a first embodiment. FIGS. 2A, 2B, and 2C are schematic diagrams of the character input device according to a first embodiment. FIGS. 3A, 3B, and 3C are schematic diagrams of the operation unit included in the character input device according to a first embodiment. FIG. 4 is a flowchart showing the operation of the character input device according to a first embodiment. FIG. 5 is a schematic diagram of the character input device according to a first embodiment. FIG. 6 is a flowchart showing the operation of the character input device according to a first embodiment.

An example structure will be described in more detail with reference to FIGS. 2A to 2C based on the structure of the character input device 10 shown in FIG. 1.

As shown in FIGS. 1, 2A, 2B, and 2C, the character input device 10 includes the operation unit 110 and the character output unit 150.

FIG. 2A is a schematic diagram of the character input device 10 held without a tilt, or parallel with a reference axis. For example, the device body is a rectangle with the longer sides and the shorter sides, and the body is oriented with the longer sides parallel with a vertical direction (in a vertically oriented state) in the figure. FIG. 2B is a schematic diagram of the character input device 10 held at a leftward tilt from the reference axis. FIG. 2C is a schematic diagram of the character input device 10 held at a rightward tilt from the reference axis. The state in FIG. 2A is a first attitude in an embodiment.

The structure will now be described in more detail. The operation unit 110 shown in FIG. 2A is at a default position.

As shown in FIG. 2B, the user tilts the character input device 10 to the left. In response to the tilt, the attitude detector 140 detects the attitude change of the character input device 10 corresponding to the leftward tilt. The attitude detector 140 outputs information about the attitude change corresponding to the leftward tilt to the controller 130. The controller 130 displays the operation unit 110 to the left. The user performs key entry with the operation unit 110.

As shown in FIG. 2C, the user tilts the character input device 10 to the right. In response to the tilt, the attitude detector 140 detects the attitude change of the character input device 10 corresponding to the rightward tilt. The attitude detector 140 outputs information about the attitude change corresponding to the rightward tilt to the controller 130. The controller 130 displays the operation unit 110 to the right. The user performs key entry with the operation unit 110.

FIGS. 3A to 3C show the specific structure of the operation unit 110 in FIGS. 2A to 2C.

FIG. 3A shows the operation unit 110 in the same state as in FIG. 2A. A straight line including the left edge shown in FIG. 3A is defined as a left-hand-operation reference line, and a straight line including the right edge is defined as a right-hand-operation reference line.

The operation unit 110 is displayed in a balanced manner. For example, for a user operation with the left hand, the Japanese character SA is farther from the left-hand-operation reference line than the Japanese character A. More specifically, the Japanese character SA is more difficult to input than the Japanese character A in a user operation with the left hand. In contrast, the Japanese character A is more difficult to input than the Japanese character SA in a user operation with the right hand.

FIG. 3B shows the operation unit 110 in the same state as in FIG. 2B, and the user operates the character input device 10 with the left hand. In this state, the user tilts the character input device 10 to the left. In response to the tilt, the displayed operation unit 110 is shifted toward the left-hand-operation reference line. More specifically, character input with the left hand in this state is easier than in the state in FIG. 3A.

FIG. 3C shows the operation unit 110 in the same state as in FIG. 2C, and the user operates the character input device 10 with the right hand. In this state, the user tilts the character input device 10 to the right. In response to the tilt, the displayed operation unit 110 is shifted toward the right-hand-operation reference line. More specifically, character input with the right hand in this state is easier than in the state in FIG. 3A.

In this manner, the user can shift the displayed operation unit 110 left or right by simply tilting the character input device 10 to the left or right with a one-hand operation.

This improves the operability with a one-hand operation, and thus improves user convenience.

The operation of the character input device will be described in detail with reference to FIG. 4. FIG. 4 is a flowchart showing the operation of the character input device according to a first embodiment, showing the operation at the first attitude. The operation other than at the first attitude will be described later with reference to FIG. 5.

The user activates the character input function of the character input device 10, and the character input device 10 displays a software keyboard that is the operation unit 110 (S101).

The user grips the character input device 10 in one hand and tilts the character input device 10. The attitude detector 140 detects the attitude (S102).

When the attitude detector 140 detects the attitude change corresponding to a leftward tilt of the character input device 10, the controller 130 shifts the operation unit 110 toward the left (S103).

The operation unit 110 appears on the left (S104) and receives key entry (S105). The operation unit 110 ends receiving the key entry (S106).

In response to the end of the key entry, the controller 130 returns the display of the operation unit 110 to a default (S107). The default corresponds to the state in FIGS. 2A and 3A.

When the attitude detector 140 detects the attitude change corresponding to a rightward tilt of the character input device 10, the controller 130 shifts the operation unit 110 toward the right (S113).

The operation unit 110 appears on the right (S114) and receives key entry (S115). The operation unit 110 ends receiving the key entry (S116).

In response to the end of the key entry, the controller 130 returns the display of the operation unit 110 to a default (S107). The default corresponds to the state in FIGS. 2A and 3A.

When the attitude detector 140 detects a tilt of the character input device 10 in a direction other than leftward and rightward directions, or more specifically, the attitude detector 140 detects an attitude change corresponding to leaning forward or backward, the processing returns to step S101, in which the operation unit 110 is displayed.

In this manner, a tilt of the character input device 10 can be detected, and the operation unit 110 can be repositioned depending on the tilt.

This processing improves user operability and thus improves convenience.

FIG. 5 is a schematic diagram of the character input device according to a first embodiment. FIG. 6 is a flowchart showing the operation of the character input device according to a first embodiment.

The character input device 10 in FIG. 5 with the structure described above is oriented substantially perpendicular to the first attitude of the character input device 10. For example, the rectangular body described above is oriented with the longer sides substantially parallel with a horizontal direction (in a horizontally oriented state). More specifically, this state is a second attitude in an embodiment.

When the character input device 10 at the second attitude is tilted to the left or the right, the character input device 10 repositions the operation unit 110 in accordance with the second attitude.

This operation of the character input device 10 will now be described in more detail with reference to the flowchart in FIG. 6.

The attitude detector 140 detects the attitude of the character input device 10 (S121).

For the character input device 10 horizontally oriented (second attitude) (S121), the controller 130 displays the operation unit 110 in a horizontally oriented manner (S122).

In this state, the controller 130 repositions the operation unit 110 in accordance with the second attitude (S123).

For the character input device 10 vertically oriented (first attitude) (S121), the controller 130 displays the operation unit 110 in a vertically oriented manner (S131).

The controller 130 then repositions the operation unit 110 in accordance with the attitude of the character input device 10 (S132). The specific processing after steps S123 and S132 is the same as the processing in FIG. 4.

In this manner, the character input device 10 oriented as shown in FIG. 5 can reposition the operation unit 110 in accordance with the second attitude to satisfy the user needs.

### Example Structure 2

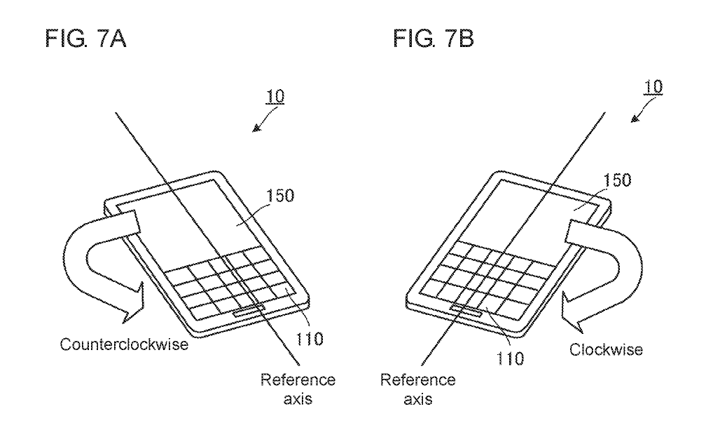

FIGS. 7A and 7B are schematic diagrams of a character input device according to a second embodiment.

A second embodiment differs from a first embodiment in the directions in which the character input device 10 is tilted. The other components and processes are the same as those in a first embodiment, and will not be described.

As shown in FIG. 7A, the user turns the character input device 10 about the reference axis, for example, counterclockwise by a predetermined angle. The attitude detector 140 then detects the attitude change of the character input device 10 corresponding to the tilt with a counterclockwise turn, and displays the operation unit 110 to the left.

Similarly, as shown in FIG. 7B, the user turns the character input device 10 about the reference axis, for example, clockwise by a predetermined angle. The attitude detector 140 then detects the attitude change of the character input device 10 corresponding to the tilt with a clockwise turn, and displays the operation unit 110 to the right.

For such a tilt including a turn, the user can shift the displayed operation unit 110 left or right by simply tilting the character input device 10 clockwise or counterclockwise with a one-hand operation.

This improves the operability in a one-hand operation, and improves the usability for the user.

In the structure described above, the operation unit may be shifted left or right when a tilt of the character input device continues for a predetermined period of time. The predetermined period of time is, for example, one second.

In the structure described above, a tilt of the character input device is detected. In some embodiments, the acceleration of the tilting character input device may be detected. The operation unit may be shifted left or right when the acceleration exceeds a predetermined rate.

1. A character input device for inputting a character, the device comprising:
an operation unit included in a body of the character input device, the operation unit comprising a software keyboard, the operation unit receiving a character input performed with the software keyboard;
a sensor detecting an attitude change of the body; and
a controller repositioning the software keyboard in accordance with the detected attitude change.

2. The character input device according to claim 1, wherein the sensor detects the attitude change by detecting a rightward tilt or a leftward tilt from a first attitude of the body.

3. The character input device according to claim 2, wherein in response to the sensor detecting the body oriented in a second attitude relative to the first attitude, the controller repositions the software keyboard in accordance with the second attitude.

4. The character input device according to claim 1, wherein the controller returns a position of the software keyboard to a default position in response to the character input ending.

5. The character input device according to claim 2, wherein the controller returns a position of the software keyboard to a default position in response to the character input ending.

6. The character input device according to claim 3, wherein the controller returns a position of the software keyboard to a default in response to the character input ending.

7. A character input method implemented by a computer, the method comprising:
receiving a character input with a software keyboard included in a body of a character input device for the character input;
detecting an attitude change of the body; and
repositioning the software keyboard in accordance with the attitude change.

8. A non-transitory computer-readable recording medium storing a character input program, which when read and executed, causes a computer to perform operations comprising:
receiving a character input with a software keyboard included in a body of a character input device for the character input;
detecting an attitude change of the body; and
repositioning the software keyboard in accordance with the attitude change
